(19) United States
(12) Patent Application Publication
(10) Pub. No.: US 2026/0282183 A1
(43) Pub. Date: Sep. 17, 2026

(54) ELECTRIC POWER SUPPLY APPARATUS FOR AN ELECTRIC FURNACE

(71) Applicant: DANIELI AUTOMATION S.P.A., BUTTRIO (UD) (IT)

(72) Inventor: Antonello MORDEGLIA, BUTTRIO (UD) (IT)

(21) Appl. No.: 19/167,415

(22) PCT Filed: Mar. 20, 2024
(86) PCT No.: PCT/IT2024/050061

§ 371 Date: Sep. 22, 2025

(30) Foreign Application Priority Data
Mar. 24, 2023 (IT) 102023000005706

(51) Int. Cl. H05B 7/148; H02M 1/12; H02M 5/44; H05B 1/02; H05B 7/00

(52) U.S. Cl. CPC H05B 7/148; H02M 1/126; H02M 5/44; H05B 1/023; H05B 7/005

(57) ABSTRACT

An electric power supply apparatus for an electric furnace includes at least one base power supply module configured to convert electric energy supplied by a three-phase electric network and supply at output at least one pair of single-phase alternating currents and voltages having a desired intensity and frequency, and having at least two sub-modules, each of which includes a rectifier device, a direct current intermediate circuit, and at least one inverter device.

### FIELD OF THE INVENTION

The present invention concerns an electric power supply apparatus for an electric furnace for steelmaking applications for the production of steel, or for other sectors that process metals or vitreous materials, or other similar or comparable materials. The electric power supply apparatus is, in particular, applicable to electric furnaces that operate with alternating electric currents and voltages.

### BACKGROUND OF THE INVENTION

As is known, the electric furnaces used to melt metal in steelmaking applications require an efficient electric power supply system that supplies high powers.

It is also known that a melting process comprises several steps, which generally comprise a step of boring the metal material, a step of melting the material and a step of refining.

The power and electric energy required by the electric furnace during the melting process vary even significantly from one step to another, therefore it is necessary to suitably adapt the amount of electric energy supplied on each occasion.

In particular, the power absorbed by the electric furnace during the step of boring the metal material, or even during the melting step, is generally greater than the one required during the refining step and, depending on the type of material that is fed into the furnace, can vary considerably even within the same process step.

Power supply apparatuses for electric arc furnaces are known that connect to a power supply network, generally three-phase, and convert the electric voltage and current supplied by the power supply network into electric voltage and current suitable to power the electrodes of the electric arc furnace.

Known apparatuses comprise a rectifier device, which transforms the alternating current supplied by an electric network into direct current, and one or more inverter devices which transform the direct current into alternating current to power the electrodes.

The amount of electric energy supplied to the electrodes is then adjusted by appropriately commanding the inverter devices.

Generally, these inverter devices comprise one or more switches that are opened and closed with a high frequency, whereby if it is necessary to dynamically change the amount of energy supplied to the electric furnace, and even if there are a plurality of inverter devices, fluctuations in the electric voltage can be generated that can also have an effect back along the circuit, creating problems for the electric network.

These inverter devices, in fact, cause the modulation of the current that is performed, generate current harmonics that can be harmful if fed into the electric power supply network.

Apparatuses of a known type are described in U.S. Pat. No. 11,346,605 and U.S. Pat. No. 11,382,191, for example.

There is therefore the need to perfect an electric power supply apparatus for an alternating current or direct current user device that can overcome at least one of the disadvantages of the state of the art.

One purpose of the present invention is to provide an apparatus and a method for powering an electric arc furnace which allows to effectively regulate the operation and power of an electric furnace according to requirements.

Another purpose of the present invention is to provide an apparatus and implement a method which allows to adjust the characteristics of voltage and current supplied to an electric furnace, in particular an arc furnace, in order to guarantee the stability of the electric arc during the various steps of the melting process.

Another purpose of the present invention is to perfect a balanced electric power supply apparatus which reduces any disturbances on the side of the electric power supply network to a minimum.

Another purpose of the present invention is to perfect an electric power supply apparatus which prevents the generation of electric current harmonics that are potentially harmful if introduced into the power supply network.

Another purpose of the present invention is also to perfect an electric power supply apparatus which has a modular construction and can therefore be adapted based on the requirements of the plant or the characteristics of the electric furnace to which it has to be applied.

Another purpose of the present invention is to perfect a method for powering an electric furnace which allows to supply the desired and necessary quantity of electric energy on each occasion and, at the same time, prevents possible disturbances toward the electric power supply network.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, there is provided an electric power supply apparatus according to the present invention, suitable to power an electric furnace for steelmaking applications for the production of steel, or for other sectors that process metals or vitreous materials, or other similar or comparable materials. The apparatus comprises at least one base power supply module connected, during use, between a three-phase electric network and a three-phase power supply line, the base power supply module being configured to convert the electric energy supplied by the electric network and supply at output at least one pair of single-phase alternating currents and voltages having a desired intensity and frequency.

Preferably, the power supply apparatus comprises a plurality of base modules, which are connected in parallel to each other between the three-phase network and the load to be powered.

The load to be powered can be an electric furnace, for example an electric arc furnace provided with electrodes disposed passing through a covering vault of the furnace, a submerged arc electric furnace, a ladle furnace, or similar or comparable furnaces, which during use are connected to the power supply line.

According to some embodiments, the or each base power supply module comprises at least two sub-modules, each suitable to supply a single-phase voltage and current.

In particular, the or each base power supply module comprises a number of sub-modules corresponding to the number of connections, that is, the number of phases, to be supplied at output. In accordance with the present invention, each sub-module comprises, disposed in succession one to the other, a rectifier device configured to transform a three-phase alternating electric current and voltage into direct electric current and voltage, a direct current intermediate circuit, or DC-link, configured to store electric energy, and at least one inverter device connected to the intermediate circuit and configured to transform the direct current and voltage into supply alternating current and voltage suitable to supply a different phase of the power supply line.

In particular, in the at least one base module there is provided both a direct current intermediate circuit, or DC-link, for each of the phases that the base power supply module supplies at output, and also at least one inverter device connected to each of the DC-links. The number of DC-links and phases is therefore the same. For example, if there are two output phases, there will be a total of two DC-links, if there are three output phases, there will be three DC-links, in the case of six phases there will be six DC-links, and so on.

In accordance with the present invention, all the intermediate circuits of the sub-modules are short-circuited with respect to each other.

In other words, the direct current intermediate circuits of all the sub-modules of a same base module are all at the same electric potential, and this allows to compensate for a set of harmonics and to achieve a common average value, thus reducing the magnitude of the disturbances in one or more sub-modules.

Furthermore, in the event that the direct current intermediate circuit of a sub-module malfunctions, the other sub-module or sub-modules can also compensate for the non-functioning sub-module and possibly supply energy to the inverter device connected to the direct current intermediate circuit that is not working.

This solution, therefore, thanks to the redundancy of the rectifier devices and the short-circuit between the different intermediate circuits, allows to supply all the desired output phase connections in any case, even if with reduced powers.

On the one hand, this configuration allows to store energy, at least temporarily, and at the same time create a separation between the load to be powered and the power supply network, so as to prevent any disturbances and unwanted harmonics and on the other it allows to absorb any unbalances between the at least two phases.

In accordance with one aspect of the present invention, each sub-module comprises two or more inverter devices, for example a number comprised between two and eight, which are connected in parallel to each other to the same direct current intermediate circuit and all supply a single output phase.

Preferably, the number of inverter devices in each sub-module is comprised between four and six.

In accordance with one aspect of the present invention, the apparatus comprises at least one three-phase transformer device for each base module, configured to transform the electric energy supplied by the electric network into electric energy with appropriate values of voltage and current suitable to power the sub-modules. Preferably, this transformer device is physically separated and distanced from the respective sub-modules, and it can also be made in a different building and connected to the respective sub-modules by means of suitable cables.

In accordance with one aspect of the present invention, the transformer device comprises a single transformer primary provided with three-phase inputs connected, during use, to the phases of the electric network, and a plurality of transformer secondaries each connected with respective three-phase outputs to a respective sub-module. In this solution, the single transformer primary is coupled to all the transformer secondaries. This solution allows to reduce the impact of disturbances on the network side, that is, reduce the harmonic content and the reactive power exchanged in the network by the combination of the transformer secondary and the rectifier device.

According to some embodiments, the rectifier device comprises a plurality of rectifier circuits, in particular one for each of the input phases, which are all connected to the same direct current intermediate circuit.

According to some embodiments, the phases in the respective transformer secondaries of a same base power supply module are out of phase with each other so as to obtain a balance between the currents and/or the respective electric voltages within each base power supply module.

According to possible embodiments, in the case of two transformer secondaries, these can have respective phase angles that are positive and negative with respect to a common reference.

According to other embodiments, in the case of three transformer secondaries, two of them can be respectively out of phase by a phase angle in one or the other direction with respect to the third transformer, and so on in the case of four or more transformer secondaries.

In accordance with another aspect of the invention, the apparatus comprises a plurality of base modules connected in parallel to each other between the electric network and the power supply line, wherein each base module receives at input three three-phase connections and supplies at output two, three, four, six or more single-phase voltage and current connections.

If the apparatus comprises two or more base modules connected in parallel, the intermediate circuits of the respective sub-modules of each of the base power supply modules are short-circuited with respect to each other by means of shorting connections only with the other intermediate circuits of the same base power supply module, and are not connected to the intermediate circuits of the other base power supply modules.

The number of base modules can be multiplied according to requirements. For example, the number of base power supply modules can be comprised between 2 and 60, for example 12, 24, 30, 36, 48 or even intermediate numbers, even or odd.

This modular construction advantageously allows to adapt the power supply apparatus to the requirements of a plant, both in its design phase in order to define the total number of base modules in relation to the required size and productivity needs, and also during use, making it possible to optimally adjust the electric energy supplied in relation to requirements, for example by keeping only some of the base modules active on each occasion.

In general, if there are two or more base power supply modules, the phase connections of the respective transformer devices can assume configurations that are partly or entirely different from each other, in order to balance and equalize the voltages and currents both inside each base power supply module, and also overall between one base power supply module and another.

In accordance with another aspect of the present invention, a method for the electric power supply of an electric furnace comprises:
supplying, by means of a three-phase electric network, an alternating electric current and voltage having a predefined frequency to at least one base module comprising two or more sub-modules, each configured to receive at input three-phase electric voltages and currents and supply at output respective single-phase alternating voltages and currents having a desired intensity and frequency;
powering one or more electrodes of the electric furnace by means of the single-phase alternating voltages and currents.

In accordance with one aspect of the power supply method according to the present invention, in each of the sub-modules there is provided a rectifying of the respective phase voltages and currents to obtain a direct electric voltage and current which are common for the three phases, a temporary storage of energy and a separation between the electric network and the electrodes by means of a direct current intermediate circuit, and an inversion of the direct electric voltage and current by means of at least one inverter device to obtain respective single-phase alternating electric voltage and current.

In accordance with another aspect of the invention, the method provides that all the direct current intermediate circuits of the at least one base module are short-circuited with respect to each other so as to bring them to a same electric potential.

In this way, the inverter devices belonging to each sub-module of the same base module operate on common direct voltages and currents, which can be considered as an average value between the voltages and currents supplied in each sub-module by a respective rectifier device.

In accordance with one aspect of the present invention, the method provides to supply the three-phase alternating electric current and voltage to a plurality of base modules connected in parallel to each other between the electric network and a power supply line of the electrodes, and to manage and command at least the inverter devices of one or more of the plurality of base modules in relation at least to the specific steps of a melting process performed in the electric furnace and/or to the material to be melted, in order to vary one or more parameters of the electric current and voltage supplied on each occasion to the electrodes according to requirements.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic view of an electric power supply apparatus according to the invention in accordance with a first embodiment, having a base module comprising two sub-modules and applied to an electric arc furnace;

FIG. 2 is a schematic view of an electric power supply apparatus according to the invention in accordance with a second embodiment, having a base module comprising three sub-modules and applied to an electric arc furnace;

FIG. 3 is a schematic view of the simplified circuit of two sub-modules;

FIG. 4 is a schematic view of an electric power supply apparatus according to some variants, comprising two base modules, each with three sub-modules, applied to an electric arc furnace;

FIG. 5 is a schematic view of an electric power supply apparatus according to another variant, in which each base module comprises six sub-modules, applied to a submerged arc furnace.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

We will now refer in detail to the possible embodiments of the invention, of which one or more examples are shown in the attached drawings, by way of a non-limiting illustration. The phraseology and terminology used here is also for the purposes of providing non-limiting examples.

The embodiments described here with reference to the attached drawings concern an electric energy supply apparatus 10 for an electric furnace 11, in particular an alternating-current electric furnace.

The electric furnace 11 can be for example an electric arc furnace (EAF) or a submerged arc furnace (SAF), of the type usable in a plant 15 for steelmaking applications for melting scrap or other metal material by means of an electric arc ignited by two or more electrodes 16A, 1B, 16C, 16D, 16E, 16F generally indicated as a whole with number 16.

These electrodes 16 generally enter the inside of the furnace crucible from the vault, and can normally be moved toward or away from the material to be melted.

The power supply apparatus 10 comprises electric energy supply means 12, suitable to supply electric energy having predefined voltage, current and frequency values.

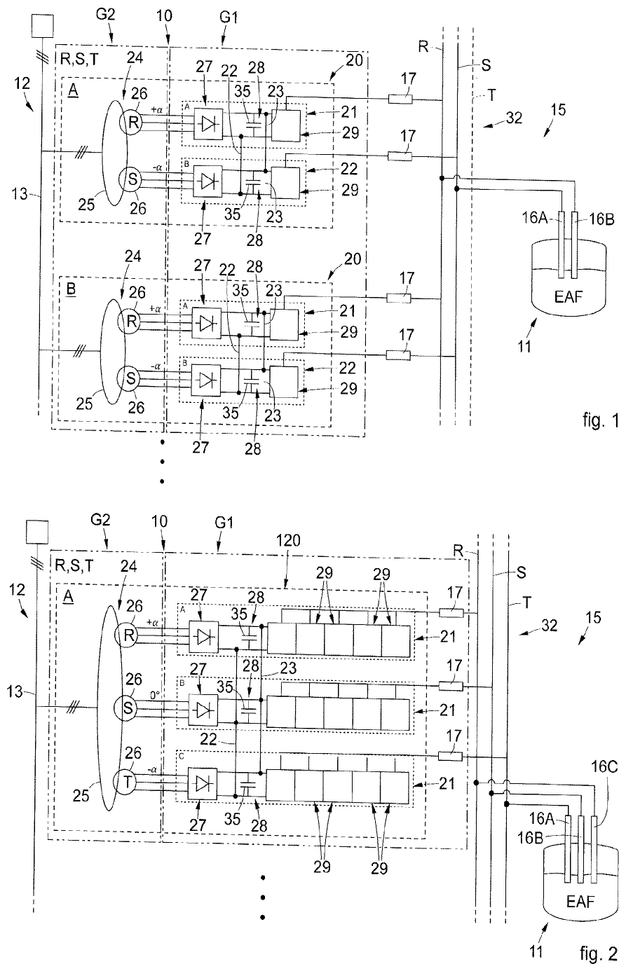

According to some embodiments, the electric energy supply means 12 comprise a three-phase electric network 13, configured to supply alternating current electric energy. In FIG. 1, the letters R, S and T indicate the three phases.

The power supply apparatus 10 is connected to the electric network 13 and to the electric furnace 11 by means of suitable input and output connection means.

The input and output connection means generally comprise connection lines, connectors and suchlike.

The apparatus 10 comprises at least one base power supply module 20, 120, 220 connected, during use, between the electric network 13 and the electric furnace 11 and configured to convert the electric energy supplied by the electric network 13 and supply at output at least a pair of single-phase alternating electric currents and voltages having a desired intensity and frequency.

Each phase supplied by the sub-module can be connected to an electrode 16 of the electric furnace 11, possibly by means of a power supply line 32.

In particular, if two electrodes 16A, 16B are provided, each phase of the pair of phases can be connected to one of them (FIG. 1).

If three electrodes 16 are provided, the power supply line 32 can be of the three-phase type and each phase R, S, T can be connected to a respective electrode 16A, 16B, 16C, 16D, 16E, 16F (FIGS. 2, 4 and 5).

If the number of electrodes 16 is lower or higher, only some of the three phases R, S, T can be connected, or two or more phases can be connected to two or more electrodes 16.

The electric current and voltage of the phases R, S, T supplied to the electrodes 16 can vary in relation to the progression of the melting and/or refining process of the metal material in the furnace 11.

By way of example, the electric current supplied to the electrodes 16 can have a value of the order of a few tens of kA, for example comprised between 40 kA and 70 kA for an electric furnace 11 of approximately 100 tons. The electric power supplied to the electrodes 16 can have a value of the order of a few tens of megawatts, for example comprised between 35 MW and 80 MW.

In accordance with one aspect of the present invention, the base module 20, 120, 220, comprises at least two sub-modules 21, each suitable to receive at input three-phase electric energy and supply at output single-phase alternating electric current and voltage suitable to supply, for example, a phase R, S, T of the three-phase power supply line 32, or directly one of the electrodes 16.

By way of example, FIG. 1 shows a first embodiment of an apparatus 10 in which the base module 20 comprises only two sub-modules 21, which are indicated with the letters A and B for the sole purpose of facilitating their identification.

As will also be described below, the number of sub-modules 21 can also be greater than two, for example three, four, six or more.

Each sub-module 21 comprises, disposed in succession one to the other, a rectifier device 27, configured to transform the three-phase alternating electric current and voltage into direct electric current and voltage, a direct current intermediate circuit 28, or DC-link, common for all phases, and at least one inverter device 29, connected to the intermediate circuit 28 and configured to transform the direct voltage and current into alternating voltage and current.

In accordance with the present invention, all the intermediate circuits 28 of the base power supply module 20 are short-circuited with respect to each other.

In other words, between the respective intermediate circuits 28 belonging to the same base power supply module 20 there are respective electric connections 22, 23 with impedance substantially equal to zero, or in any case negligible, whereby the intermediate circuits 28 of all the sub-modules 21 are substantially all at the same electric potential.

In this way, the inverter devices 29 connected to each one of them operate on direct voltages and currents having a same value, substantially equal to the average value of the voltages and currents of the various sub-modules 21.

As can be seen in the attached drawings, the shorting connections 22, 23 are present only between the respective intermediate circuits 28 belonging to the sub-modules 21 of a same base power supply module 20. However, there are no connections 22, 23 between intermediate circuits 28 belonging to respective sub-modules 21 of different base power supply modules 20.

According to some embodiments, the apparatus 10 can comprise one or more inductors 17 for each sub-module 21, connected downstream of the inverter device(s) 29.

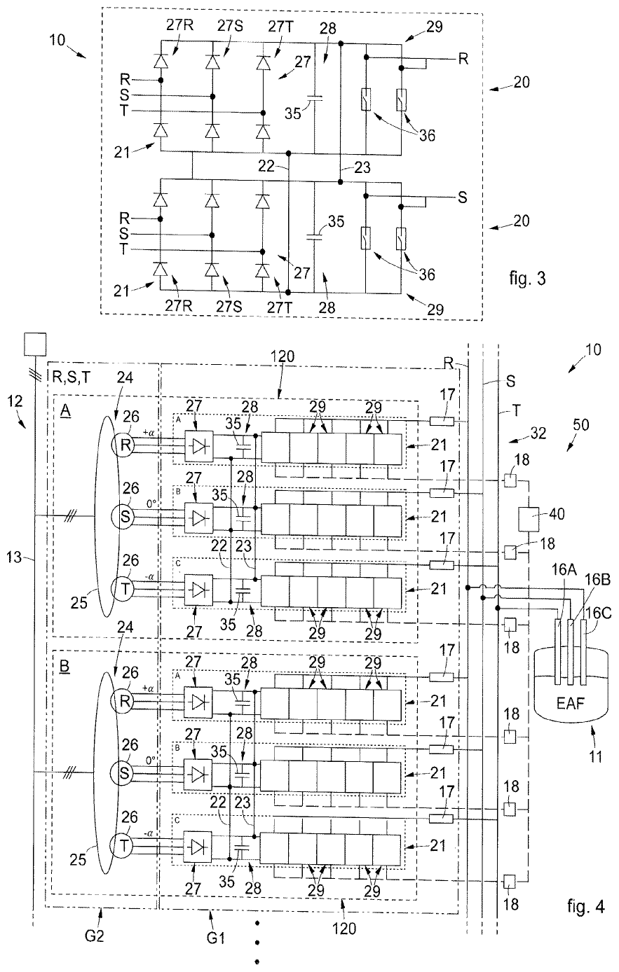

According to some embodiments, for example described with reference to FIG. 3, each rectifier device 27 can comprise a respective rectifier circuit 27R, 27S, 27T for each phase.

The rectifier device 27 can be made as a diode bridge or a thyristor bridge, and comprise devices chosen from diodes, Silicon Controlled Rectifier (SCR), Gate Turn-Off (GTO) thyristor, Integrated Gate-Commuted Thyristor (IGCT), Metal-Oxide Semiconductor Controlled Thyristor (MCT), Bipolar Junction Transistor (BJT), Metal-Oxide Semiconductor Field-Effect Transistor (MOSFET), Insulated-Gate Bipolar Transistor (IGBT) and Silicon Carbide (SiC) device.

According to some embodiments, each sub-module 21 is provided with its own direct current intermediate circuit 28. To the intermediate circuit 38 there are connected, on one side, the rectifier device, that is, each rectifier circuit 27R, 27S, 27T, and one or more inverter devices 29 on the other side.

This intermediate circuit 28 can comprise one or more capacitors 35, for example a capacitor bank, suitable to store energy and create a separation between the rectifier device 27 and the one or more inverter devices 29, and therefore also between the electric network 13 and the electrodes 16, that is the power supply line 32.

According to some embodiments, the inverter devices 29 can comprise one or more switches 36 chosen, for example, from a thyristor or a transistor, of the following types: Gate Turn-Off (GTO) thyristor, Integrated Gate-Commuted Thyristor (IGCT), Metal-Oxide Semiconductor Controlled Thyristor (MCT), Bipolar Junction Transistor (BJT), Metal-Oxide Semiconductor Field-Effect Transistor (MOSFET), Insulated-Gate Bipolar Transistor (IGBT), or suchlike. The switches 36 can generally be associated with respective diodes, not shown.

According to some embodiments, each sub-module 21 comprises a plurality of inverter devices 29, connected in parallel to each other to the intermediate circuit 28, which all supply a same output phase, for example a phase R, S, T of the power supply line 32.

For example, M inverter devices 29 can be provided, wherein the number M is comprised between 2 and 8, preferably between four and six.

The operation of the inverter devices 29, and therefore of the switches, can be adjusted by a control unit 40 in order to obtain at output a current having desired intensity and frequency. The control unit 40 is shown by way of example in FIG. 3, it can however be applied to all the embodiments described here.

The control unit 40 can be configured to manage and command the inverter devices 29 in relation to the specific steps of the melting process performed in the electric furnace 11, in order to vary one or more parameters of the electric current and voltage supplied to the electrodes 16, for example the intensity and/or frequency.

In accordance with possible solutions of the present invention, the control unit 40 can comprise, or be connected to, adjustment devices 18, configured to adjust the supply electric frequency of the electric voltage and current to be supplied to the electrodes 16, in order to obtain a contextual variation of the reactance value of the power supply circuit of the electrodes 16.

By way of example, the adjustment devices 18 can comprise a hysteresis modulator or a PWM (Pulse-Width-Modulation) modulator.

The apparatus 10 comprises at least one three-phase transformer device 24 associated with at least one base power supply module 20, configured to transform the electric energy supplied by the electric network into electric energy with appropriate voltage and current values suitable to power the sub-modules 21.

In particular, the apparatus 10 comprises a transformer device 24 for each base module 20.

The transformer device 24 comprises at least one transformer primary 25 provided with three-phase inputs connected, during use, to the phases of the electric network 13, and a plurality of transformer secondaries 26, each connected with respective three-phase outputs to a respective sub-module 21.

The number of transformer secondaries 26 is equal to the number of phases to be supplied at output, and therefore to the number of sub-modules 21.

According to some embodiments, preferably the transformer device 24 is physically separated and distanced from the respective sub-modules 21, and it can also be made in a different building, or in a different plant site, and connected by means of suitable cables to the respective sub-modules 21.

For example, the apparatus 10 can comprise an adjustment unit G1, comprising at least the sub-modules 20, 120, 220 and possibly the inductors 17, which is disposed in proximity to the furnace 11, and a transformation unit G2, comprising the transformer devices 24, separated and distanced from the adjustment unit G1 even by a few dozen meters or more.

According to possible variants, also in relation to the spaces available, the two units G1, G2 can also be made in a same building.

In FIGS. 1, 2 and 4, the transformer secondaries 26 have been indicated by way of example with the letters R, S or T as a function of the phase respectively supplied by the sub-module 21 with which they are associated.

In accordance with one aspect of the present invention, the transformer device 24 comprises a single transformer primary 25 which is coupled to all the transformer secondaries 26.

According to some embodiments, the phases R, S, T of the transformer primary 25 and of the transformer secondary 26 can be connected according to a star or delta configuration.

According to preferred embodiments, the phases R, S, T of the transformer primary 25 and of the transformer secondaries 26 are connected in a delta configuration.

According to one aspect of the invention, the phases in the respective transformer secondaries 26 of the same base power supply module 20, 120, 220 are out of phase with each other so as to obtain a balance between the currents and/or the respective electrical voltages inside each base power supply module 20.

According to possible embodiments, the transformer secondaries 26 associated with a same base module 20, 120, 220 all have connections between the phases that are different from each other.

In the example of FIG. 1, for each base module 20, the transformer device 24 comprises one transformer primary 25 and two transformer secondaries 26 indicated by the letters R and S.

In this case, the phases of the two transformer secondaries 26 can be connected with a delta conformation and have a respective positive and negative phase angle α symmetrical with respect to a common reference.

As an example, the phase angle α can be comprised between 15° and 25°.

FIG. 2 shows a second example embodiment of an apparatus 10 comprising a base module 120 with three sub-modules 21 each comprising a rectifier device 27, the base module 120 is configured to supply at output three different phases R, S, T of current and voltage. The three intermediate circuits 28 are all connected to each other by means of the shorting connections 22, 23.

In the example case of FIG. 2, the transformer secondary 26S has a zero phase angle, while the remaining transformer secondaries 26R, 26T are out of phase by a respective phase angle α, respectively positive and negative.

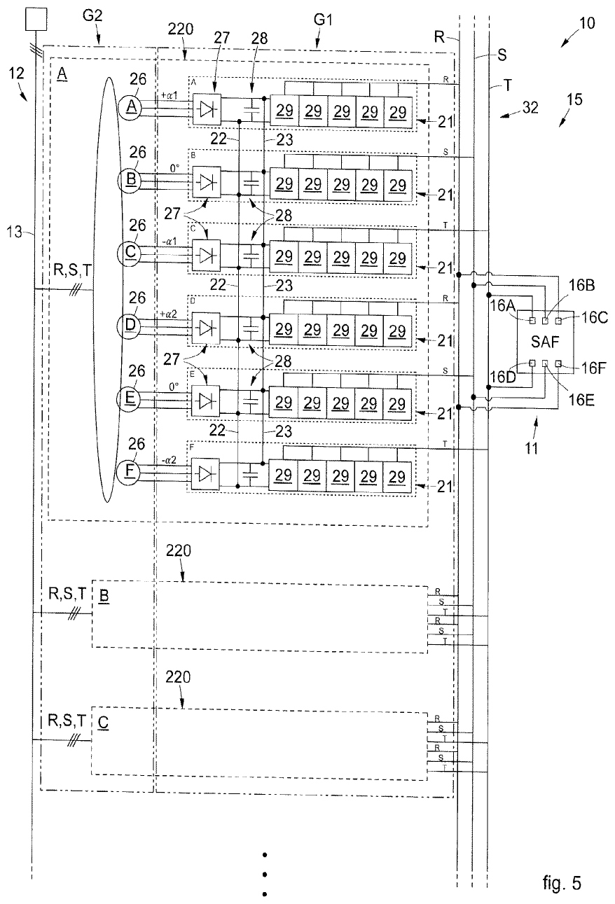

FIG. 5 shows another embodiment of an apparatus 10, in this case connected by way of example to an electric furnace 11 of the submerged arc SAF type which, in the example case, comprises six electrodes 16A-16F, although their number can be different.

The apparatus 10 according to this embodiment comprises one or more base modules 220 each provided with six sub-modules 21, the intermediate circuits 28 of which are connected to each other by means of the shorting connections 22, 23. In this example, there are five inverter devices 29, however, as mentioned above, this number can also be smaller or larger.

In this case, the six sub-modules 21 of the base module 220 are connected in pairs to the phases R, S, T of the power supply line 32, and each electrode 16 is connected to one of such phases R, S, T. In the example case, each phase R, S, T is connected to two different electrodes 16.

In this embodiment, the transformer primary 25 is coupled to six transformer secondaries 26.

According to some embodiments, it can be provided that the phases of the transformer secondaries 26 are out of phase, as in the example of FIG. 3, or differentiated phase angles can also be provided. For example, the transformer secondaries 26A, 26C can be out of phase by a first phase angle α1 with respect to the transformer secondary 26B, while the transformer secondaries 26D, 26F can be out of phase by a second phase angle α2, different from the first angle α1, with respect to the transformer secondary 26E.

It is clear, however, that other combinations of connections and/or respective phase angles are possible.

According to one aspect of the invention, the apparatus 10 can comprise N base modules 20, 120, 220 connected in parallel to each other between the electric network 13 and the electric furnace 11. The number N of base modules can be chosen depending on requirements or parameters such as, for example, the power required for the furnace 11, the productivity required, the overall number of electrodes 16 to be powered.

The number N can be, for example, variable between 2 and 60, for example 3, 4, 5, 6, 8, 10, 12, 18, 24, 36, 48, or even other intermediate even or odd numbers.

Preferably, the number N of base modules 20, 120, 220 is such that the overall number of sub-modules 21 is a multiple of three, so as to uniformly supply the three phases R, S, T of the power supply line 32.

By way of example, FIG. 4 shows an apparatus 10 comprising two or more base modules 120 according to the embodiment of FIG. 2, indicated with the letters A and B, which are connected on one side to the electric network 13 and on the other to the load 11, in this case through the power supply line 32.

This configuration with several modules can also be achieved by replacing the base modules 120 of the embodiment of FIG. 2 with the base modules 20, 220 of the embodiment of FIG. 1 or 5.

According to some embodiments, in the case of an apparatus 10 comprising a plurality of base modules 20, 120, 220, it can be provided that all the transformer devices 24 are substantially the same as each other.

According to possible variants, in the case of a plurality of base modules 20, 120, 220, it can be provided that at least one transformer device 24 has the connections between the respective phases R, S, T of the transformer primary 25 and/or of the transformer secondary 26 of a different type compared to at least one other transformer device 24.

By “connections of a different type” we mean both the case in which the phases R, S, T of at least one of either the transformer primary 25 or the transformer secondary 26 of one of the transformer devices 24 are connected with a star connection, while the phases R, S, T of another are connected with a delta connection, and also the case in which both have a connection of the same type, for example delta, but there is a phase shift of a certain angle between the respective phases R, S, T.

According to other embodiments, in the event that several base modules 20, 120, 220 are provided, the connections between the input and output phases R, S, T of the respective transformers 24 can all be different from each other, or they can repeat themselves according to a desired order.

The different conformations of the phase connections in the transformers 24 of one base module 20, 120, 220 or between several base modules 20, 120, 220 are preferably chosen in such a way as to be overall different from each other, at least according to the type of connection or a phase angle between the phases, in order to obtain a balance of both the current and the voltage within the single base module 20, as well as overall within the apparatus 10.

Some embodiments described here also concern a plant 15 comprising a power supply apparatus 10 according to the invention and an electric furnace 11 provided with two or more electrodes 16 each connected to a phase R, S, T of the power supply line 32.

According to other embodiments, there is also provided a method for the electric power supply of an electric furnace 11 provided with two or more electrodes 16 which comprises:
supplying, by means of a three-phase electric network 13, an alternating electric current and voltage having a predefined frequency to at least one base module 20, 120, 220 comprising at least two sub-modules 21, each configured to receive at input three-phase electric voltages and currents and supply at output respective single-phase alternating voltages and currents having a desired intensity and frequency;
powering the electrodes 16, 16A-16F of the electric furnace 11 by means of the single-phase alternating voltages and currents.

According to one aspect of the present invention, in each of the sub-modules 21, 22, 23 there is provided a rectifying of the respective phase voltages and currents R, S, T to obtain a common direct electric voltage and current for the three phases R, S, T, a temporary storage of energy and a separation between the electric network 13 and the electrodes 16, 16A-16F by means of a direct current intermediate circuit 28, and an inversion of the direct electric voltage and current by means of at least one inverter device 29 to obtain respective single-phase alternating electric voltages and currents, wherein all the direct current intermediate circuits 28 of the at least one base module 20, 120, 220, are short-circuited with respect to each other so as to bring them to a same electric potential.

The respective single-phase electric voltages and currents supplied by the base modules 20 are suitable to each supply a different phase R, S, T of the power supply line 32.

In accordance with some embodiments, the method according to the invention provides to control at least the operation of the inverter devices 29 in relation to the type of electric furnace 11 to be powered, or to the characteristics of the melting process performed therein, for example the type of material to be melted, the powers required, the number of electrodes 16 used, or the different process steps.

According to some embodiments, the method provides to adjust the inverter devices 29 by means of a PWM adjustment or a hysteresis adjustment.

According to other embodiments, in the event that there are several base modules 20, 120, 220, the method according to the invention can also provide to verify, on each occasion, the requirements of the plant 15 or the characteristics of the electric furnace 11 or the material to be melted, and determine the characteristics of the voltage and current to be supplied to the electrodes 16, and activate, on each occasion, all and only the base modules 20, 120, 220 necessary and sufficient to supply a certain voltage and current.

It is clear that modifications and/or additions of parts may be made to the power supply apparatus 10 as described heretofore, without departing from the field and scope of the present invention, as defined by the claims.

In the following claims, the sole purpose of the references in brackets is to facilitate reading and they must not be considered as restrictive factors with regard to the field of protection defined by the specific claims.

1. Electric power supply apparatus for an electric furnace for steelmaking applications or sectors that process metals or vitreous materials, comprising at least one base power supply module configured to convert electric energy supplied by a three-phase electric network and supply at output at least one pair of single-phase alternating currents and voltages having a desired intensity and frequency, and having at least two sub-modules each of which comprises, disposed in succession one to the other, a rectifier device configured to transform a three-phase alternating electric current and voltage into direct electric current and voltage, a direct current intermediate circuit, or DC-link, configured to store electric energy, and at least one inverter device connected to said intermediate circuit and configured to transform the direct current and voltage into single-phase alternating electric current and voltage, wherein all the intermediate circuits of the at least one base power supply module are short-circuited with respect to each other by means of shorting connections.

2. Apparatus as in claim 1, further comprising a plurality of base power supply modules connected in parallel to each other between said electric network and said electric furnace.

3. Apparatus as in claim 2, wherein the intermediate circuits of each of said base power supply modules are short-circuited by means of said shorting connections only with the other intermediate circuits of the same base power supply module and are not connected to intermediate circuits belonging to different base power supply modules.

4. Apparatus as in claim 1, wherein each of said sub-modules comprises a plurality of inverter devices which are connected in parallel to each other to the same direct current intermediate circuit and contribute to supply a common single-phase alternating electric voltage and current.

5. Apparatus as in claim 1, further comprising at least one transformer device associated with said at least one base power supply module and configured to transform the electric energy supplied by said electric network into electric energy with suitable values of voltage and current which are suitable to power said sub-modules.

6. Apparatus as in claim 5, wherein said transformer device comprises at least one transformer primary and a number of transformer secondaries corresponding to the number of phases to be supplied at output and to the number of sub-modules of said at least one base power supply module.

7. Apparatus as in claim 6, further comprising a single transformer primary provided with three-phase inputs connected, during use, to the phases of said electric network, said single transformer primary being coupled to all said transformer secondaries, each of which is connected to one of said sub-modules, and in that the phases of at least two transformer secondaries of said at least one base power supply module are out of phase with each other.

8. Apparatus as in claim 2, further comprising a plurality of transformer devices, each connected between said electric network and one of said plurality of base modules.

9. Apparatus as in claim 1, wherein said or each base power supply module comprises a number of sub-modules comprised between 2 and 8, and a corresponding number of intermediate circuits short-circuited with respect to each other.

10. Apparatus as in claim 1, further comprising a control unit configured to manage and command at least said inverter devices in relation to the specific steps of a melting process performed in the electric furnace in order to vary one or more parameters of the electric current and voltage supplied on each occasion to one or more electrodes.

11. Plant for melting a metal material comprising a power supply apparatus as in claim 1 connected between an electric network and a power supply line, and an electric furnace provided with two or more electrodes, wherein each of said electrodes is connected to a phase of said power supply line.

12. Method for powering an electric furnace for steelmaking applications or sectors that process metals or vitreous materials, having two or more electrodes said method comprising:
supplying, by means of a three-phase electric network, a three-phase alternating electric current and voltage having a predefined frequency to at least one base module comprising two or more sub-modules, each configured to receive at input three-phase electric voltage and current and supply at output respective single-phase alternating voltages and currents having a desired intensity and frequency;
powering respective electrodes of said electric furnace by means of said single-phase alternating voltages and currents,
wherein in each of said sub-modules, there is provided a rectifying of the respective phase voltages and currents to obtain a direct electric voltage and current which are common for the three phases, a temporary storage of energy and a separation between said electric network and said electrodes by means of a direct current intermediate circuit, and an inversion of the direct electric voltage and current by means of at least one inverter device to obtain respective single-phase alternating electric voltages and currents, wherein the method provides a short-circuit with respect to each other all the intermediate circuits of said at least one base power supply module by means of shorting connections in such a way as to bring them to a same electric potential.

13. Power supply method as in claim 12, wherein the method provides to supply said three-phase alternating electric current and voltage to a plurality of base modules connected in parallel to each other between said electric network and a power supply line of said electrodes, and to manage and command at least said inverter devices of one or more of said plurality of base modules in relation at least to the specific steps of a melting process performed in the electric furnace and/or to the material to be melted, in order to vary one or more parameters of the electric current and voltage supplied on each occasion to said electrodes according to requirements.
